(19) United States
(12) Patent Application Publication
(10) Pub. No.: US 2005/0027732 A1
(43) Pub. Date: Feb. 3, 2005

(54) Method for object oriented handling of relational information

(75) Inventor: Lauri Kalima, Espoo (FI)

Correspondence Address: YOUNG & THOMPSON, 745 SOUTH 23RD STREET, 2ND FLOOR, ARLINGTON, VA, 22202, US

(73) Assignee: NOLICS OY, HELSINKI (FI)

(21) Appl. No.: 10/899,028

(22) Filed: Jul. 27, 2004

(30) Foreign Application Priority Data
Jul. 28, 2003 (FI) 20031108

(51) Int. Cl. G06F 17/30

(52) U.S. Cl. 707/101

(57) ABSTRACT

The invention relates to a method for modeling relations in an object-relational mapping system. The method maps relations as an object pointer located in a child object pointing to a parent object and as a relation-object-type member of the parent object. Updating the relation is arranged so that it is performed only when there is a possibility that the relation or some of its elements is out-of-date.

The invention relates to object-oriented systems, and especially to handling of relational-type data in object-oriented format.

Nowadays, software applications are usually written by means of object-oriented languages. However, data storing methods are mostly still relation-based. Between these different data mapping methods, one may construct a conversion means, an object-relational converter. Such known conversion means are, for example, solutions of code generator type, solutions utilising a graphical modeling tool, solutions based on XML definition language, and solutions based on byte code post-processing. Also other methods and combinations of the above-mentioned are used.

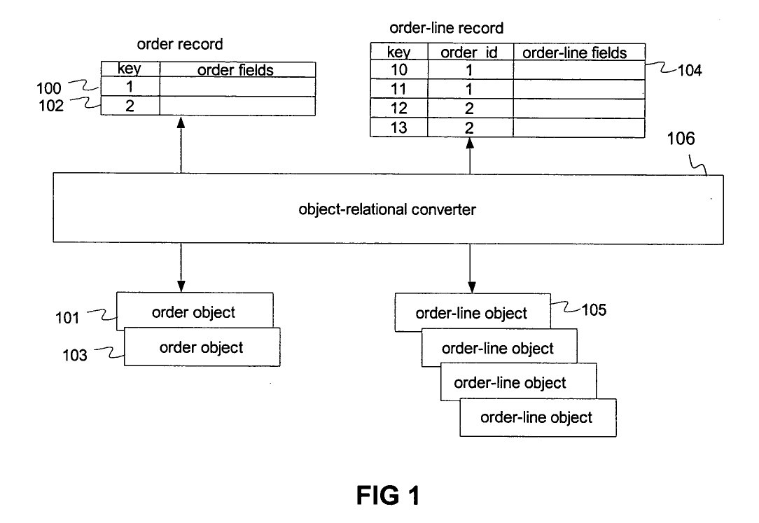

FIG. 1 shows a relation of order-order line type, and illustrates the operation of an object-relational converter 106. The object-relational converter converts data content from relational format to object-oriented format and vice versa. An order record 100 converts to an order-type object 101, respectively, another order record 102 converts to another order-type object 103. The converter performs the same measures for order-line records, for example, an order-line record 104 converts to an order-line-type object 105. Interrelations of records are mapped with object pointers between objects.

Converting relational-format data to object-oriented-format data is called object loading in the application area, and conversion in the other direction is called storing, saving or persisting.

A basic principle of an object-relational converter is to load objects only when they are required. Late loading is important, especially when using objects linked to each other. For efficiency, for example, an order-type object is not loaded until when using an object pointer from an order line, which pointer points to the object in question, and not, for example, when loading the order line. If all objects linked to each other were loaded at once, the arrangement would be inefficient, as such objects which are not required in the handling at that time could thus be loaded. For example, when loading an order line in such an arrangement, one would also load an order for there is a reference from the order line to the order. Furthermore, in such arrangement, product-type objects pointed by order-line-type objects would be loaded, and so forth. Thus, the number of objects to be loaded would become great.

A problem in current object-relational converters is the handling of relations. In relational-format data, child rows of a relation include a foreign key, which points to a parent row. The parent row in itself does not contain information on the child rows. In an object model, a parent object must include an array consisting of object pointers, or some other similar data structure, the object pointers of which point to the child objects of the parent object.

This non-compliance between data models creates problems when data is converted from relational format to object-oriented format, and vice versa:
a) Relational model cannot store data if child objects do not have pointers to respective parent objects.
b) Relational model is inefficient if parent records keep a record of their child records, for this replicates the information which is already required according to item a).
c) In many practical applications, an object-oriented system cannot efficiently handle data if one cannot access child objects through parent objects.

A known method for solving this problem is to include in the parent object an array consisting of object pointers pointing to its child objects, and to retain in child objects pointers pointing to parent objects. This is, however, problematic as is illustrated in the following examples.

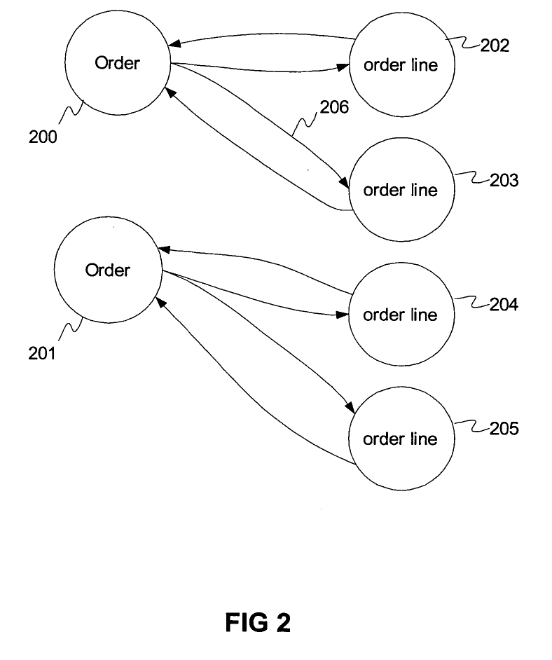

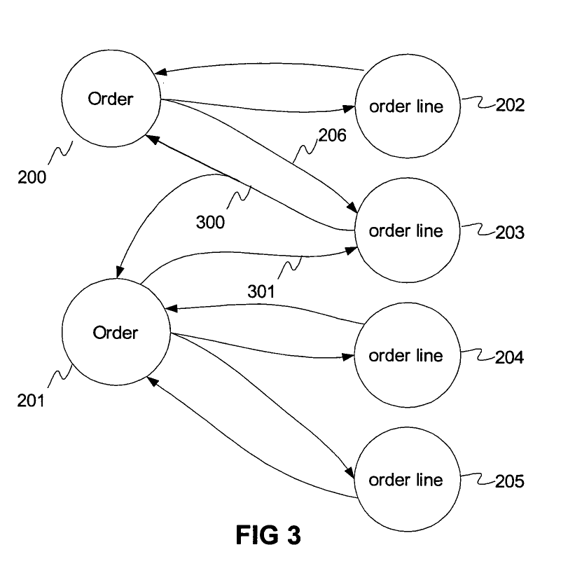

FIGS. 2 and 3 illustrate an example of a relational-format order converted to object-oriented format.

FIG. 2 shows two orders 200 and 201 mapped with objects. Each order includes two order lines 202-205. Arrows illustrate interdependencies of objects in an object model; for example, arrow 206 indicates that there is an object pointer from an order object 200 to an order line 203.

Let us assume that one handles order line 203, and wants to edit it so that it is associated with order 201 instead of order 200. FIG. 3 shows measures to be performed then:
a) moving object pointer 300 of order line 203 to point to order 201,
b) nullifying pointer 206 pointing from order 200 to order line 203, and
c) inserting a new pointer 301 to the pointer array of order 201, which pointer points to order line 203.

This known method has the following disadvantages:
Because a parent-child relation is modeled bidirectionally, steps b and c are useless and cause error-proneness as they must always be coded case-specifically by hand.
Steps b and c cannot be performed if no order object is yet loaded. Useless loading of an order object causes inefficiency. Furthermore, steps b and c cannot be performed in most known techniques if order-line objects are not loaded.
If one must be able to undo a change, it is extremely laborious to compile a case-specific program code, which provides that all relational changes are undone to the state before the change.

A possible solution for the above-mentioned problem is to implement a method in the child object, which method in all possible change situations of an object pointer of a child object pointing to a parent object would track the effects of the change. Such a method is, however, laborious to create, as one has to prepare for these changes, inter alia, in the following situations:
loading of a child object,
change of an object pointer of a child object pointing to a parent object, and
if used object-relational converter supports transactions (as it usually does), when undoing a transaction stored in the memory, one must know how to reset the old pointer.

In addition, one must see to it that all changes in the object pointer pointing from the child object to the parent object are performed through this method. The basic problem of this method is, however, that all objects relevant to the relation must be loaded before changes may be performed. This is especially problematic when relations are large, that is, they include a large set of objects.

Let us take an example of a system which has customers, and each customer has many customer-specific products. When transferring a product from Customer A to Customer B, using current techniques, one has to load both Customer A's all products and Customer B's all products. This is problematic from the point of view of efficiency, as in systems based on object-relational converter, it is most important from the point of view of efficiency that unnecessary loading operations are avoided, as the duration of operations related to loading is principally of totally different magnitude than the duration of other operations associated with objects.

As depicted above, current methods have disadvantages, and a better solution is required.

Now an invention has been made one objective of which is to produce a new method for handling of relational-format data in object-oriented format. A starting point of the invention is to solve the above-mentioned problems, or, at least minimise the disadvantages related to them.

The invention may be implemented in an environment in which object persistence is implemented by means of an object-relational mapping system. A basic idea of the invention is to map a parent-child relation in the object format bidirectionally, but to update changes made in the relation to the parent object essentially only when the parent object is used. This is enabled by keeping a record of changes made to the relation with a suitable change observation mechanism. For example, a so-called relation object may be created to the parent object in order to manage the relation.

According to a first aspect of the invention, a method is implemented for handling of relational-type data in object-oriented format, said relational-type data comprising at least first and second data elements, said relational-type data being mapped to object-oriented format so that said first data elements are mapped with parent objects, said second data elements are mapped with child objects, and relations between said first and second data elements are mapped with object pointers between said child objects and parent objects. The method comprises recording a change directed at said relational-type data as having happened when handling a child object associated with said relational-type data, and handling said relational-type data through a parent object associated with said relational-type data, which handling comprises
establishing by means of said recordings whether said parent object is up-to-date regarding said relational-type data, and
updating said parent object, if said parent object is not up-to-date regarding said relational-type data.

Updating a parent object is typically performed just before handling the relational-type data, but the update may also be performed when being in a suitable waiting state, such as when waiting a user input or some resource to be freed.

One may keep a record of changes associated with relation types, for example, globally, child-object-type-specifically or relation-type-specifically. One may keep a record of changes by means of, inter alia, a change counter and/or time stamps.

Handling a child object associated with relational-type data may be considered to mean loading and/or deleting said child object, and/or changing the value of object pointer associated with said relational-type data in said child object, and undoing the change of the value of an object pointer associated with said relational-type data in said child object.

In this context, the term relation type is defined in the following way: one relation type encompasses child objects of one type and specifically named object pointers of one type inside said child objects, said object pointers inside child objects pointing to parent objects of one type.

The method according to the first aspect of the invention may be implemented so that,
a change directed at the relation type is recorded as having happened when handling an object pointer associated with said relation type in a child object being of the type of child object associated with said relation type, and data included in said relation type is handled through a parent object being of the type of parent object associated with said relation type, which handling comprises
examining by means of changes recorded to said relation type whether said parent object is up-to-date regarding said relation type, and
updating said parent object regarding said relation type if said parent object is not up-to-date regarding said relation type.

A change associated with the relation type is may be recorded as having happened also when handling objects inherited from a child object.

According to an embodiment of the invention, one keeps a record of changes by means of a relation-type-specific change counter, and a relation object is formed to a parent object for each relation type encompassing said parent object, said relation object comprising a child object data structure for object pointers pointing to child objects, and a change-counter variable for said storing of the state of the change counter. This relation object may be ignored when storing said parent object back to relational format.

Said child object data structure may be, for example, one of the following: an array, a collection, a vector, a list, a linked list, a dictionary and a combination of the above.

Updating the parent object regarding said relation type may be performed by updating the relation object associated with said relation type in said parent object, for example, in the following way:
emptying said child object data structure if it is not empty,
loading child objects possibly associated with said parent object, being of child-object type associated with said relation type,
examining loaded child objects being of the child-object type associated with said relation type, and searching for those child objects which have an object pointer associated with said relation type and pointing to the parent object comprising said relation object,
inserting to said child object data structure object pointers to those child objects which have an object pointer associated with said relation type pointing to said parent object, and
copying the current value of the change counter associated with said relation type to said change-counter variable.

In connection with the above-mentioned loading, one may load, for example, all child objects being of the child-object type associated with said relation type, or just those which possibly associate with the parent object in question. Child objects to be loaded may also be chosen with other criteria.

As an example, when establishing whether said parent object is up-to-date regarding said relational-type data
one may compare the current value of the change counter associated with said relation type to the value stored in the change-counter variable of the relation object relating to said relation type, and
one may identify that said parent object is not up-to-date regarding said relation type, if the current value of said change counter and said value stored in the change-counter variable differ from each other.

The above-mentioned handling of data included in said relation type may concern, for example, performing such a method with which one searches for data associated with child objects associated with said relation type, such as the number of elements in said child object data structure or at least one of the object pointers stored in child object data structure.

One must notice that using relation types is flexible in connection with the invention. A child object associated with one relation type may be a parent object associated with another relation type, a child object of one type may belong to more than one relation type, and a parent object of one type may belong to more than one relation type. Two different relation types may encompass the same parent-object type and child-object type, if the object pointers between these are named in a different way in different relation types. If a parent object is associated with more than one relation type, the parent object has its own relation object for each relation type.

According to a second aspect of the invention, a computer program is implemented according to Claim 27.

According to a third aspect of the invention, a data processing device is implemented according to Claim 28.

The dependent claims concern advantageous embodiments of the invention. The contents of the dependent claims related to one aspect of the invention may also be applied to the other aspects of the invention.

The combination of change observation to bidirectional object pointers according to the invention enables efficient design, which facilitates creating efficient code at run-time. Also error possibilities decrease. In addition, relations are up-to-date when they are used.

In an implementation according to the invention, one may make several sequential changes to a child-object-type objects of the relation, and not to update a parent object until data associated with the relation is attempted to be handled through the parent object. Whereas in known prior-art solutions, in connection with changing each object pointer pointing from a child object to a parent object, one has to update also the object pointers of the parent object.

Above, in connection with the depiction of known prior-art, an example was presented of a system, which includes customers and each customer has many customer-specific products. When transferring a product from one customer to another, in most known solutions supporting late loading and bidirectional mapping of relation, one has to load both Customer A's all products and Customer B's all products. In the present invention, it is adequate to transfer only the product, there is no requirement to load relations before they are handled through a customer. If the relation is accessed after a change, the relation updates itself with the changes made earlier.

The invention will now be described in detail by way of examples with reference to the accompanying figures, in which

FIG. 1 shows a relation of order-order line type and illustrates functioning of a object-relational converter;

FIGS. 2 and 3 illustrate an example of a relational-format order converted to object-oriented format;

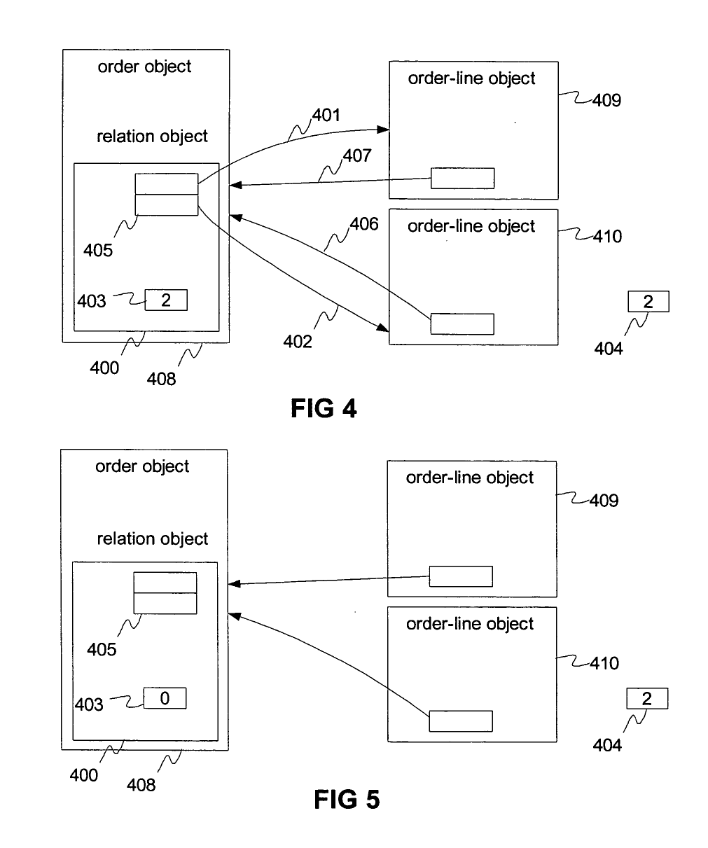

FIG. 4 shows a relation converted to object-oriented format;

FIG. 5 shows the relation of FIG. 4 in a situation in which a parent object comprising the relation has just been loaded;

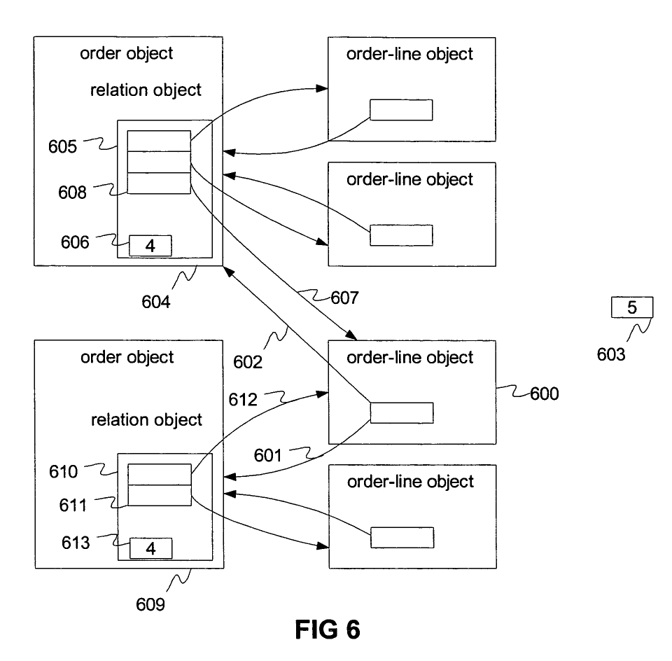

FIG. 6 illustrates the transfer of a child object belonging to a relation from one relation to another;

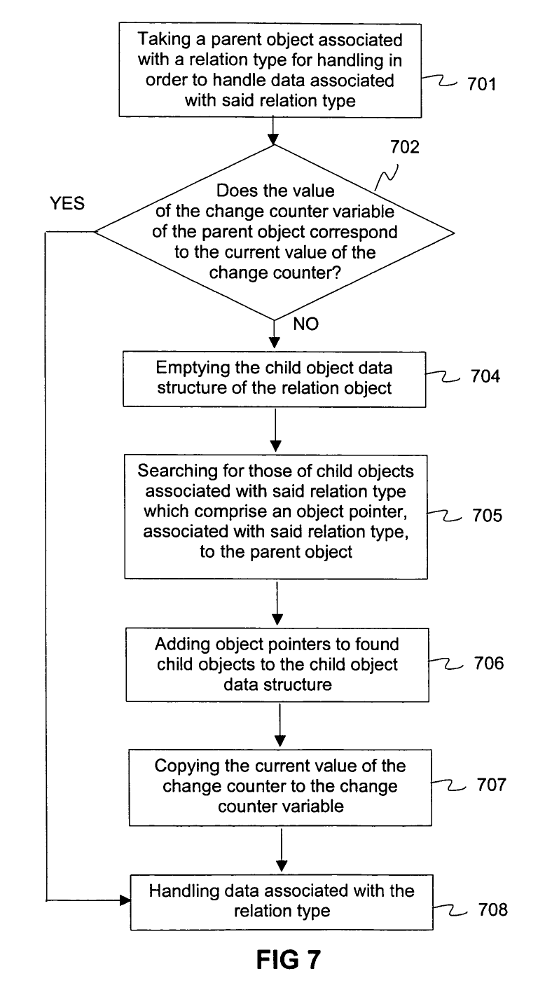

FIG. 7 is a flow diagram illustrating a method according to an embodiment of the invention; and

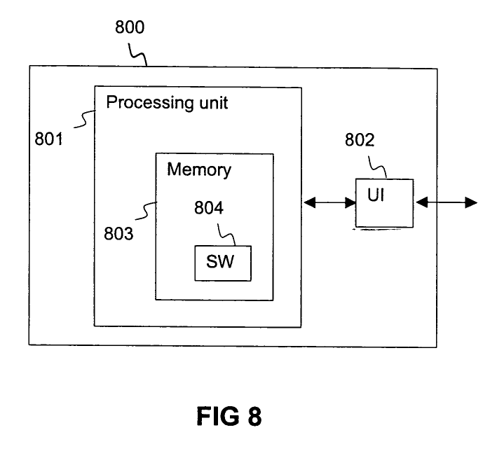

FIG. 8 shows a data processing device according to an embodiment of the invention.

In an embodiment according to the invention, a so-called relation object is formed to parent object(s) associated with relational-type data for managing relational-type data. Said relation object comprises a data structure for object pointers pointing to child objects and equipment for controlling the updating requirement of the data structure.
The data structure may be, for example, an array, a vector, a collection or other similar data structure, which comprises object pointers pointing to child objects. In embodiments of the invention described below, an array is principally used as the data structure. Naturally, also other data structures may be used.
The equipment for controlling the updating requirement of data structure may be, for example, a change-counter variable into which the value of the change counter is stored when updating a parent object. Also any other mechanism, with which one can examine if the array of a relation object was updated before or after the last change directed at a relation, may be used. For example, time stamps may be used.

In embodiments of the invention described below, an incrementable change counter is used for observing changes and requirement for updating. In a solution according to an embodiment of the invention described below, the change counter is initially set to zero and the counter is incremented with one by every one change. A change counter may, naturally, be implemented also in other ways.

A change counter or a similar change observation mechanism works most efficiently when one establishes a separate change counter for each relation type. In this context, one relation type is seen to encompass child objects of one type and object pointers of one type, specifically named inside said child objects (the type of object pointers defining implicitly the type of parent object associated with the relation type). For example, orderline.order_id and orderline.order_id2 are of different relation types, likewise freightline.order_id and orderline.order_id are of different relation types. Above in the notation class.pointer, class means the child object in which the pointer is defined. If a child object has been inherited from another child object in which an object pointer, associated with the relation type, pointing to a parent object, is already defined, the class in the inheritance chain means that child object class in which the pointer in question is defined for the first time.

Between one child-object type and one parent-object type there may be several different relation types. For example, from a membership-type child object there may be object pointers indicating membership and deputy membership to a parent object of organisation type. Now the object pointers indicating membership and deputy membership belong to different relation types, but the only difference between the relation types is in the naming of the object pointers.

Child objects comprise object pointers to their respective parent objects. Child objects may have more than one object pointer, if the child object belongs to more than one relation. It is essential that there exists one object pointer per each relation.

Below it is assumed that changes associated with relations are observed relation-type-specifically on the level of child class/child class pointer. If a child object belongs, for example, to two relations, one advantageously establishes for these relations two change counters, which are identified with, for example, identifiers childclass.parent1 and childclass.parent2. Also other observation levels may be used within the scope of the invention. Observation may be implemented, for example, globally with a single counter or class-specifically.

FIG. 4 shows a relation converted to object-oriented format according to an embodiment of the invention. The figure shows an order object 408, which corresponds a certain order record in relational form, and two order-line objects 409 and 410 which correspond to certain order-line records in relational format. The order object is here a so-called parent object and order-line objects are child objects of the parent object. From order-line objects 409 and 410, there exist object pointers 406 and 407 to the order object 408.

The order object 408 comprises a relation object 400 which comprises an array 405 for child-object pointers 401 and 402 associated with the relation type corresponding the relation object, and a change-counter variable 403 into which is copied the value of the change counter 404 associated with the presented relation type. Because the values of the change-counter variable 403 and the change counter 402 correspond to each other, the relation object in question is up-to-date in the situation shown in the figure.

One must notice that corresponding change-counter variable exists in all parent objects in the relation object corresponding the relation type belonging to the relation in question, whereas there is only one change counter per each relation type.

In the initialisation phase, array 405 of the relation object is empty or contains null values. When a parent object including a relation object is loaded for the first time, the change-counter variable of the relation object is set to such a value which causes update of the relation object when the relation object is handled for the first time. In connection with the update, all child objects associated with the relation in question are loaded, and object pointers to the child objects are inserted to array 405 from which child objects there is an object pointer associated with the relation type in question to the parent object to be handled. Handling relation means that one tries to use some object pointer associated with relation. The relation is marked being up-to-date by setting the stored state of the change counter 403 to the same value, which the current change counter 404 of the relation type has at the moment.

The change counter 404 is incremented every time changes are made to an object pointer of any child object pointing to a parent-type object and belonging to a relation, like object pointers 406 and 407. Loading and deletion of a child object and undoing the change of a value of the above-mentioned object pointer are also counted as a change.

When handling a relation object, first one compares the state of the change-counter variable to the relation-type-specific change counter. If the state of the change-counter variable differs from the change counter of the relation type, the relation object is updated.

The updating of a relation object included in a parent object is performed, for example, in the following way:
loading all child objects associated with this certain parent object, unless they have already been loaded (alternatively, one could load all child objects which could be associated with this certain parent object),
examining all already loaded child objects associated with the relation type in question, searching for object pointers which point to this parent object (an object is considered to be associated with the relation type if it belongs to the child class of the relation type and its named object pointer is in accordance with the relation type),
updating the array of the relation object with object pointers to those child objects which have an object pointer to the parent object, and
copying the current value of the change counter of the relation type to the change-counter variable of the relation object.

One must notice that in multi-user and multi-application environment an efficient object-relational converter requires a signalling mechanism with which it receives information on when other users or applications have made changes in child objects or added or deleted child objects. The signalling mechanism must make the chosen object-relational converter to load the new, changed and deleted child objects. Such signalling mechanisms are available ready-implemented, so they are not discussed here in detail. It is advantageous to the invention that the loading of a child object belonging to the relation type by a process by itself causes incrementing of the change counter, which causes updating of relation objects included in parent objects associated with the relation type in question by all processes before handling data included in the relation type in question.

FIG. 5 shows the relation of FIG. 4 in a situation in which a parent object 408 comprising a relation has just been loaded. Let us assume that child objects 409 and 410 have already been loaded and the parent object is loaded for the first time. Then array 405 included in the relation object 400 is empty.

The change counter 404 of the relation type has been incremented in the example when child objects 409 and 410 belonging to the relation type have been loaded. When the relation object 400 included in the order 408 is handled for the first time, the relation object is updated because the values of the change-counter variable 403 and the change counter 404 differ from each other. In the update, pointers of array 405 are set to point to child objects 409 and 410 associated with the parent object 408.

FIG. 6 illustrates the transfer of a child object belonging to a relation from one relation to another. The figure shows two order objects 604 and 609 and order-line objects 600. Here also the order objects are parent objects and order-line objects are child objects. In the shown situation, all objects belonging to the relation have been loaded earlier. Let us assume that order line 600 is transferred to belong to order 604 instead of order 609. The transfer is made by changing the value of the object pointer pointing to the parent-object type object in the order-line object 600 from the situation indicated by arrow 601 to the situation indicated by arrow 602, that is, to point to order 604 instead of order 609. This change causes the increment of the change counter 603 of the relation type to value 5 (earlier value being 4).

When the relation object 605 of order 604 is handled for the first time after this change, one notices that the value of the change-counter variable 606 of the relation object 605 differs from the value of the change counter 603 of the relation type. Because of this, the relation object 605 is updated, whereby object pointer 607 is inserted into array 608 included in the relation object 605. After this, the change-counter variable 606 of the relation object is updated to value 5, that is, the same as the one of the change counter 603 of the relation type.

Respectively, when the relation object 610 of order 609 is handled for the first time, one notices that the value of the change-counter variable 613 included in the relation object 610 differs from the value of the change counter 603 of the relation type. Because of this, the relation object 610 is updated and object pointer 612 is deleted from array 611 included in the relation object 610. After this, the change-counter variable 613 of the relation object is updated to value 5, that is, the same as the one of the change counter 603 of the relation type.

One must notice that the described invention does not require that parent objects or child objects unrelated to the change are loaded before some child objects are handled. Loaded child objects belonging to the relation type and their object pointers pointing to parent objects may be handled freely, and the pointers of parent objects to child objects are not updated until one tries to handle them. This makes a significant improvement compared to known prior-art.

All the methods of the relation object with which one is able to search the relation object for data, including:
searching for the number of elements in an array
searching for an object pointer in an array
   cause the checking of the updating requirement of the relation object by means of a change observation mechanism before data is returned to the party invoking the method.

Typically, a programmer does not directly handle the table of a relation object, which comprises object pointers pointing to child objects, but child objects are added to the relation and child objects are removed from it by handling object pointers in child objects pointing to parent objects. The internal structures of the relation object are advantageously protected with object-oriented programming techniques so that they cannot be handled directly.

Furthermore, all object-pointer-type variables of a child object pointing to a parent object associated with the relation type are protected advantageously so that they cannot be modified without incrementing the change counter associated with the relation type in question.

In programming languages supporting the concept of a property, the above protection may be performed so that the above-mentioned relation object variables and said object-pointer variables are defined to be of a property type, whereby they may be accessed only with the functions of get and set types. In programming languages which do not support properties, the protection may be performed, for example, so that variables may be accessed only with two functions (getter, setter) or other similar technique so that the checking of an updating requirement in connection with a relation object by means of a change observation mechanism is forced in connection with the function getter, and in connection with a child object the incrementing of the change counter is forced in connection with the function setter.

A many-to-many relation is mapped, according to an embodiment of the invention, in two or more one-to-many relations by using an intermediate object, which has pointers to parent objects of each relation type.

No special methods are required for storing objects in relational format. The relation object has no counterpart in the relational model, so relation objects are simply ignored when storing parent objects. In connection with storing a child object, the pointer to a parent object is converted with the technique of the used object-relational converter to a foreign key or other reference to a table corresponding the parent object. It is not relevant to the invention how this conversion is performed. It is well known by those skilled in the art that many different well-known techniques may be used.

FIG. 7 is a flow diagram illustrating a method according to an embodiment of the invention. In the method in question, one keeps a record of changes made to relations relation-type-specifically. One relation type encompasses child objects of one type and object pointers of one type, specifically named inside said child objects, said object pointers inside child objects pointing to parent objects of one type. A change directed at the relation type is recorded as having happened always when handling an object pointer associated with said relation type in a child object being of child-object type associated with said relation type, and one keeps a record of changes by means of a relation-type-specific change counter.

In step 701 of FIG. 7, a parent object associated with a desired relation type is taken for handling. A so-called relation object is formed to the parent object in question for each relation type associated with the parent object in question. A relation object comprises a child object data structure for object pointers pointing to child objects and a change-counter variable for storing the state of the change counter. The current value of the change counter associated with the respective relation type is copied to the change counter in connection with updating the relation object.

In step 702, it is examined if the values of the change-counter variable of the parent object's relation object and the change counter associated with the relation in question correspond to each other. If this is the case, the data of parent object regarding the relation type is up-to-date. Thus, desired data associated with the relational type is up-to-date and one may move directly to step 708 and handle the desired data.

If the values of the change-counter variable and the change counter do not correspond each other, the parent object has to be updated regarding the relation object in question. First, in step 704, the child object data structure of the relation object is emptied of earlier values, unless the data structure is already empty. Then, in step 705, one examines the child objects of the child-object type associated with the relation type in question, and searches them for those child objects, which have an object pointer associated with said relation type to the parent object. Before this step, child objects to be examined have to be loaded so that they can be examined (not shown in flow diagram). For this, one may load all child objects associated with the relation type in question or the child objects (possibly) associated with the parent-object type in question. In step 706, one inserts to the child object data structure object pointers to found child objects, and in step 707, one copies the current value of the change counter associated with the relation type in question to the change-counter variable of the relation object.

After this, the data included in the parent object is up-to-date, and desired data associated with the relation type is handled in step 708.

FIG. 8 shows a data processing device 800 according to an embodiment of the invention, which may be, for example, a general-purpose computer or a server or some other suitable device.

The data processing device 800 comprises a processing unit 801 and a user interface (UI) 802 communicating with it. The user interface 802 comprises typically a display and a keyboard and possibly another control device (not shown) by means of which the data processing device in question may be used. The invention may also be utilised in devices, which do not have an actual user interface.

The processing unit 801 comprises a processor (not shown), a memory 803 and an object-oriented computer program 804 stored into the memory to be run in said processor.

The processor controls the data processing device according to the computer program 804 to handle relational-type data in object-oriented format, said relational-type data comprising at least first and second data elements, said relational-type data being mapped to object-oriented format so that said first data elements are mapped with parent objects, said second data elements are mapped with child objects, and relations between said first and second data elements are mapped with object pointers between said child objects and parent objects. The processor controls the data processing device according to the computer program 804 to record a change directed at said relational-type data as having happened when handling a child object associated with said relational-type data, and to handle said relational-type data through a parent object associated with said relational-type data so that one examines with said recordings if said parent object is up-to-date regarding said relational-type data and updates said parent object if this is not the case.

The invention was described above in connection with some embodiments without limiting the invention to these examples only. The implementation and utilising possibilities of the invention are limited solely by the appended patent claims. Thus, the different implementation alternatives of the invention defined by the claims, also equivalent implementations, are within the scope of the invention.

1. A method for handling of relational-type data in object-oriented format, said relational-type data comprising at least first and second data elements, said relational-type data being mapped to object-oriented format so that said first data elements are mapped with parent objects, said second data elements are mapped with child objects, and relations between said first and second data elements are mapped with object pointers between said child objects and parent objects, wherein the method comprises
recording a change directed at said relational-type data as having happened when handling a child object associated with said relational-type data, and
handling said relational-type data through a parent object associated with said relational-type data, which handling comprises
establishing by means of said recordings whether said parent object is up-to-date regarding said relational-type data, and
updating said parent object, if said parent object is not up-to-date regarding said relational-type data.

2. A method according to claim 1, wherein one keeps a record of changes associated with the relation type globally, child-object-type-specifically or relation-type-specifically, one relation type encompassing child objects of one type and specifically named object pointers of one type inside said child objects, object pointers inside said child objects pointing to parent objects of one type.

3. A method according to claim 1, wherein handling a child object associated with relational-type data is considered to mean loading and/or deleting said child object, and/or changing the value of an object pointer associated with said relational-type data in said child object, and/or undoing the change of the value of object pointer associated with said relational-type data in said child object.

4. A method according to claim 1, wherein one keeps a record of changes by means of a change counter and/or time stamps.

5. A method according to claim 1, wherein one relation type encompasses child objects of one type and object pointers of one type, specifically named inside said child objects, said object pointers inside child objects pointing to parent objects of one type, and wherein the method comprises
recording a change directed at the relation type as having happened when handling an object pointer associated with said relation type in a child object being of the child-object type associated with said relation type, and
handling data included in said relation type through a parent object being of the parent-object type associated with said relation type, which handling comprises
establishing by means of changes recorded to said relation type whether said parent object is up-to-date regarding said relation type, and
updating said parent object regarding said relation type if said parent object is not up-to-date regarding said relation type.

6. A method according to claim 5, further comprising
recording a change directed at the relation type as having happened when handling an object pointer associated with said relation type in an object of a class, which has been inherited from a class of the child-object type associated with said relation type.

7. A method according to claim 5, comprising
keeping a record of changes by means of relation-type-specific change counter, and
forming a relation object to parent object for each relation type encompassing said parent object, said relation object comprising a child object data structure for object pointers pointing to child objects, and a change-counter variable for said storing of the state of the change counter.

8. A method according to claim 7, comprising
storing to said child object data structure object pointers to child objects associated with the respective relation type, which child objects have an object pointer associated with said relation type to said parent object.

9. A method according to claim 7, wherein updating said parent object regarding said relation type is performed by updating the relation object associated with said relation type in said parent object.

10. A method according to claim 9, wherein update of the relation object comprises
emptying said child object data structure if it is not empty,
loading child objects possibly associated with said parent object, being of child-object type associated with said relation type,
examining loaded child objects being of the child-object type associated with said relation type, and searching for those child objects which have an object pointer associated with said relation type and pointing to the parent object comprising said relation object, and
inserting to said child object data structure object pointers to those child objects which have an object pointer associated with said relation type pointing to said parent object.

11. A method according to claim 9, wherein all child objects being of child-object type associated with said relation type are loaded.

12. A method according to claim 9, wherein update of the relation object comprises
when establishing if said parent object is up-to-date regarding said relational-type data
comparing the current value of the change counter associated with said relation type to the value of the change-counter variable stored in the relation object relating to said relation type, and
identifying that said parent object is not up-to-date regarding said relation type, if the current value of said change counter and said value stored in the change-counter variable differ from each other, and
copying (707) the current value of the change counter associated with said relation type to said change-counter variable, and.

13. A method according to claim 7, wherein said relation object is ignored when storing said parent object back to relational format.

14. A method according to claim 7, wherein said child object data structure is one of the following: an array, a collection, a vector, a list, a linked list, a dictionary and a combination of the above.

15. A method according to claim 5, wherein said handling of an object pointer associated with the relation type in a child object being of child-object type associated with said relation type is considered to mean loading and/or deleting said child object.

16. A method according to claim 5, wherein said handling of an object pointer associated with the relation type in a child object of child-object type associated with said relation type comprises changing the value of said object pointer and/or undoing a change made earlier.

17. A method according to claim 1, wherein said parent object is updated regarding said relational-type data before said relational-type data is handled.

18. A method according to claim 1, wherein said parent object is updated regarding said relational-type data when waiting a user input or release of some technical resource.

19. A method according to claim 7, wherein handling of data including said relation type concerns performing such a method with which one searches for data associated with child objects associated with said relation type, such as the number of elements of said child object data structure or at least one of the object pointers stored in the child object data structure.

20. A method according to claim 5, wherein a child object associated with one first relation type is a parent object associated with another relation type.

21. A method according to claim 5, wherein a child object of one type belongs to at least two relation types.

22. A method according to claim 5, wherein a parent object of one type belongs to at least two relation types.

23. A method according to claim 21, wherein said parent object being of one type comprises at least two relation objects corresponding at least two relation types, relation object comprising a child object data structure for object pointers pointing to child objects, and a change-counter variable for storing of the state of changer counter associated with said relation type.

24. A method according to claim 3, comprising
using the method by more than one process, and
when handling a child object by one process, causing loading of said child object in other processes, whereby the change associated with the child object becomes automatically recorded by all processes.

25. A method according to claim 1, comprising
using the method by more than one process, and
when handling a child object by one process, signalling data for performing handling to other processes, whereby the change associated with the child object may be recorded by all processes.

26. A method according to claim 1, comprising
using the method by more than one process, said more than one process using a shared change counter to record changes associated with a child object, whereby a change associated with a child object becomes automatically known for all processes.

27. A computer program comprising a routine for handling of relational-type data in object-oriented format, said relational-type data comprising at least first and second data elements, said relational-type data being mapped to object-oriented format so that said first data elements are mapped with parent objects, said second data elements are mapped with child objects, and relations between said first and second data elements are mapped with object pointers between said child objects and parent objects, said computer program implementing the following steps when running said computer program in a computer:
recording a change directed at said relational-type data as having happened when handling a child object associated with said relational-type data, and
handling said relational-type data through a parent object associated with said relational-type data, in which handling
establishing by means of said recordings whether said parent object is up-to-date regarding said relational-type data, and
updating said parent object, if said parent object is not up-to-date regarding said relational-type data.

28. A data processing device for handling of relational-type data in object-oriented format, said relational-type data comprising at least first and second data elements, said relational-type data being mapped to object-oriented format so that said first data elements are mapped with parent objects, said second data elements are mapped with child objects, and relations between said first and second data elements are mapped with object pointers between said child objects and parent objects, wherein said data processing device comprises equipment for controlling said data processing device so that in said data processing device
a change directed at said relational-type data is recorded as having happened when handling a child object associated with said relational-type data, and
said relational-type data is handled through a parent object associated with said relational-type data, which handling comprises
establishing by means of said recordings whether said parent object is up-to-date regarding said relational-type data, and
updating said parent object, if said parent object is not up-to-date regarding said relational-type data.

29. A computer program of claim 27 stored on a carrier.
